(19) United States
(12) Patent Application Publication
(10) Pub. No.: US 2006/0221175 A1
(43) Pub. Date: Oct. 5, 2006

(54) Building multimedia information distribution system

(75) Inventors: Ziming Shen, Shanghai (CN); Wei Pan, Shanghai (CN); Zhiyong Tang, Shanghai (CN)

Correspondence Address: CONNOLLY BOVE LODGE & HUTZ, LLP, P O BOX 2207, WILMINGTON, DE, 19899, US

(73) Assignee: Shanghai Visart Technologies Co. , Ltd., Shanghai (CN)

(21) Appl. No.: 10/566,621

(22) PCT Filed: Sep. 19, 2003
(86) PCT No.: PCT/CN03/00799

§ 371 Date: Apr. 10, 2006

(30) Foreign Application Priority Data
Jul. 30, 2003 (CN) 03141946.1

(51) Int. Cl. H04N 7/14

(52) U.S. Cl. 348/14.04

(57) ABSTRACT

The invention relates to a multimedia information releasing system for use in the buildings, comprising a master transmitter and one or more slave receivers. The master transmitter includes a power supply timing control module, a video source input module, a real-time information display module, a LCD display module, and a synchronous transmitting module. The slave receiver comprises a power supply timing control module, a video source input module, a real-time information display module, a LCD display module, and a synchronous receiving module. The receiving and playing functions of the video signal and real-time information are integrated in one information promulgating system. Because the master transmitter controls the slave receiver in the wireless manner, the synchronous and cyclic playing of a plurality of slave receiver can be realized in a certain range. The real-time information transmitted by the paging state can be played back in the rolling character manner. The master transmitter and slave receivers for use in the multimedia information promulgating system can be operated separately and respectively. The installation of the system, or the master transmitter and slave receivers in the system can be implemented by adhesive manner without destroying the wall structure in the buildings.

### FIELD OF THE INVENTION

The present invention relates to image or information display apparatus, more particularly to a multimedia information promulgating system for use in buildings, such as airports, stations, marketplaces, offices, cinemas, restaurants, for broadcasting various kinds of advertisements and real-time information.

### DESCRIPTION OF THE RELATED ART

In many public places, all the information broadcasting systems used in buildings utilize display devices, such as CRT TV sets, plasma TV sets, LED display, LCD display and so on, to broadcast or release advertisements and information. In such information promulgating systems, the signal source is located in a control center and a plurality of displays are distributed in different places, as shown in FIG. 1. The signal source and the displays are connected by wire. In order to display information on the displays, the signal lines and electric lines should be disposed in advance. In general, it will be taken into consideration to install the above display devices after the buildings have been found. If the buildings have been decorated, in order to dispose these signal lines and electric lines so as to install the display devices, the structure of the buildings cannot but be destroyed and it will expense time and labor, causing unnecessary loss. In addition, people are needed to turn on or turn off the devices every day, it is inconvenient in use and maintain.

### SUMMARY OF THE INVENTION

An object of the invention is to overcome the above-said drawback in the conventional information broadcasting apparatus and to provide a novel multimedia information releasing system for use in buildings, and a master transmitter and a slave receiver used in the system.

In order to realize the above-said object, the technical solutions are adopted by the invention as follows:

An aspect of the invention is to provide a multimedia information promulgating system for use in buildings, it comprises a master transmitter and at least one slave receivers. Only one transmitter is required to broadcast the same content.

The master transmitter further comprises a power supply timing control module, a video input module, a real-time information display module, a LCD display module, and a synchronous transmitting module. The power supply timing control module provides a operating power supply to other modules in said master transmitter and controls on-off state of each module in said master transmitter. The video input module decodes content stored in a storage medium or playback card and converts it into video signal and audio signal which are provided to said LCD display module. The real-time information display module receives various kinds of real-time information transmitted from a paging station and sends said information to said LCD display module. The LCD display module determines functions of said real-time information sent from said real-time information display module, plays back said content in said storage medium or playback card, and displays designated information. The synchronous transmitting module transmits a synchronous control signal to said slave receiver while controlling said LCD display module to display said content in said storage medium or playback card and said designated information.

Each of the slave receiver further comprises a power supply timing control module, a video input module, a real-time information display module, a LCD display module, and a synchronous receiving module. The power supply timing control module provides a operating power supply to other modules in said slave receiver and controls on-off state of each module in said slave receiver. The video input module decodes content stored in a storage medium or playback card and converts it into video signal and audio signal which are provided to said LCD display module. The real-time information display module receives various kinds of real-time information transmitted from a paging station and sends said information to said LCD display module. The LCD display module determines functions of said real-time information sent from said real-time information display module, plays back said content in said storage medium or playback card, and displays designated information. The synchronous receiving module receives a synchronous control signal transmitted from said synchronous transmitting module in said master transmitter while controlling said LCD display module to display said content in said storage medium or playback card and said designated information.

Another aspect of the invention is to provide a master transmitter used in the multimedia information promulgating system. The master transmitter comprises a power supply timing control module, a video input module, a real-time information display module, a LCD display module, and a synchronous transmitting module. The power supply timing control module provides a operating power supply to other modules in said master transmitter and controls on-off state of each module in said master transmitter. The video input module decodes content stored in a storage medium or playback card and converts it into video signal and audio signal which are provided to said LCD display module. The real-time information display module receives various kinds of real-time information transmitted from a paging station and sends said information to said LCD display module. The LCD display module determines functions of said real-time information sent from said real-time information display module, plays back said content in said storage medium or playback card, and displays designated information. The synchronous transmitting module transmits a synchronous control signal to said slave receiver while controlling said LCD display module to display said content in said storage medium or playback card and said designated information.

A further aspect of the invention is to provide a slave receiver for use in the multimedia information promulgating system. The slave receiver comprises a power supply timing control module, a video input module, a real-time information display module, a LCD display module, and a synchronous receiving module. The power supply timing control module provides an operating power supply to other modules in said slave receiver and controls on-off state of each module in said slave receiver. The video input module decodes content stored in a storage medium or playback card and converts it into video signal and audio signal which are provided to said LCD display module. The real-time information display module receives various kinds of real-time information transmitted from a paging station and sends said information to said LCD display module. The LCD display module determines functions of said real-time information sent from said real-time information display module, plays back said content in said storage medium or playback card, and displays designated information. The synchronous receiving module receives a synchronous control signal transmitted from said synchronous transmitting module in said master transmitter while controlling said LCD display module to display said content in said storage medium or playback card and said designated information.

### BRIEF DESCRIPTION OF THE DRAWINGS

FIG. 1 is a block diagram illustrating the structure of a conventional advertising apparatus.

FIG. 2 is a block diagram illustrating a multimedia information promulgating system in accordance with the invention.

FIG. 3 is a block diagram illustrating the multimedia information promulgating system in accordance with the invention transmits information via a paging station

FIG. 4 is a block diagram illustrating a paging receiving module in the multimedia information promulgating system in accordance with the invention receives and displays information transmitted by the paging station.

FIG. 5 is a block diagram illustrating the multimedia information promulgating system in accordance with the invention transmits information via a mobile telephone.

FIG. 6 is a block diagram illustrating a GSM/GPRS module in the multimedia information promulgating system in accordance with the invention receives information.

FIG. 7 is a block diagram of the synchronous transmitting module and the synchronous receiving module in the multimedia information promulgating system.

FIG. 8 is a waveform of a remote control code transmitted by the IR emitting unit.

FIG. 9 is a waveform of remote control coding transmitted by the IR emitting unit.

FIG. 10 is a cycle waveform of a control signal transmitted by the IR emitting unit.

FIG. 11 is a block diagram of the video source input module.

FIG. 12 is a block diagram of the flash memory card player.

FIG. 13 is a block diagram of the LCD display module.

FIG. 14 is a block diagram of a master transmitter in the multimedia information promulgating system.

FIG. 15 is a block diagram of a slave receiver in the multimedia information promulgating system.

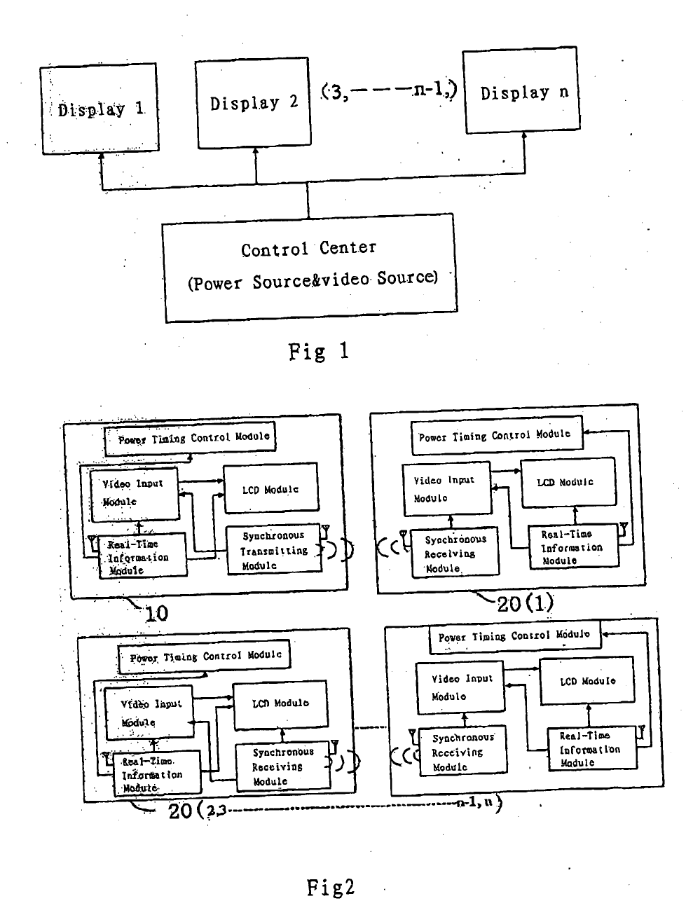

### BEST MODE OF CARRYING OUT THE INVENTION

Referring to FIG. 2, the multimedia information promulgating system for use in buildings in accordance with the invention comprises a master transmitter 10, and at least one slave receivers 20. Only one transmitter is required to broadcast the same content.

The master transmitter 10 further comprises a power supply timing control module, a video input module, a real-time information display module, a LCD display module, and a synchronous transmitting module.

The power supply timing control module provides a operating power supply to other modules in said master transmitter and controls on-off state of each module in said master transmitter. The video input module decodes content stored in a storage medium or playback card and converts it into video signal and audio signal which are provided to said LCD display module. The real-time information display module receives various kinds of real-time information transmitted from a paging station and sends said information to said LCD display module. The LCD display module determines functions of said real-time information sent from said real-time information display module, plays back said content in said storage medium or playback card, and displays designated information. The synchronous transmitting module transmits a synchronous control signal to said slave receiver while controlling said LCD display module to display said content in said storage medium or playback card and said designated information.

Each of the slave receiver 20 further comprises a power supply timing control module, a video input module, a real-time information display module, a LCD display module, and a synchronous receiving module.

The power supply timing control module provides a operating power supply to other modules in said slave receiver and controls on-off state of each module in said slave receiver. The video input module decodes content stored in a storage medium or playback card and converts it into video signal and audio signal which are provided to said LCD display module. The real-time information display module receives various kinds of real-time information transmitted from a paging station and sends said information to said LCD display module. The LCD display module determines functions of said real-time information sent from said real-time information display module, plays back said content in said storage medium or playback card, and displays designated information. The synchronous receiving module receives a synchronous control signal transmitted from said synchronous transmitting module in said master transmitter while controlling said LCD display module to display said content in said storage medium or playback card and said designated information.

As shown in FIG. 4, the paging receiving module further comprises a RF receiving unit, a signal channel filtering unit, a Chinese standard word library unit, a CPU unit for a LCD screen control board, a character display unit and a control command unit.

The RF receiving unit receives a radio paging signal, and demodulates a high frequency signal to a binary level signal which is sent to the signal channel filtering unit.

The signal channel filtering unit receives and filters the binary level signal, then compares it with its address code. If not matching, it is discarded to process. If matching, the binary level signal is sent to the CPU unit for the LCD screen control board.

Further referring to FIG. 6, the real-time information can be received by the paging receiving module or GSM/GPRS dual frequency receiving module.

The GSM/GPRS dual frequency module is a Q2403A module provided by the AVECOM company.

With the GSM/GPRS (900 MHz/1800 MHz) dual frequency module, a user can transmit information to the LCD multimedia advertising apparatus in the manner of a handset short message. This module has the same function as that of the paging receiving module, i.e., to playback a specific segment of the video source or display the real-time information.

The module is comprised of a Q2403A GSM/GPRS dual frequency module (AVECOM company), a SIM card, a character displaying unit and so on. Q2403A module reads the identification number of the SIM card and enters the telecommunication network. In this case, it is equivalent to an ordinary handset. A user can transmit information to the GSM/GPRS module as required, the control portion and display portion of the module are the same as that in the paging receiving module.

The LCD screen control board CPU unit receives binary control level signal. The CPU unit firstly judges whether the binary signal is a control signal or a display signal. If the signal is a control signal, the control command unit further judges whether the control signal is used to control the on-off of the timer or to control the content played back from the storage medium. If the signal is a display signal, corresponding character dot array is extracted from the Chinese standard word library unit and sent to the character display unit.

The character display unit displays the character dot array in the form of menu on the bottom of the LCD screen. If no new signal is received, the character string is played back circularly.

Now referring to FIG. 7, the synchronous transmitting module further comprises an infrared emitting unit, a MCU control unit, and a RF synchronous transmitting unit.

The MCU control unit simultaneously transmits a high level trigger signal to the RF synchronous transmitting unit and a level trigger signal to the IR emitting unit at a fixed trigger time. The IR emitting unit emits an infrared control signal outwards and the RF synchronous transmitting unit transmits a RF signal outwards.

The MCU control unit is an AT89C2051 single processor. Four trigger times can be set. A high lever trigger signal is transmitted to a 2262 chip in the RF circuit at the fixed trigger time, and at the same time a level trigger signal is transmitted to the IR transmitting circuit.

The RF synchronous transmitting circuit uses a surface sound wave resonator to stabilize the frequency, a peak transmission power is 0.25 W, an operation frequency is at 315 MHz. The RF circuit transmits a 8 bit radio address code after receiving the trigger signal.

The IR transmitting circuit uses a SC6121 IR remote control coding circuit. When the IR transmitting circuit receives a high level pulse transmitted from the RF synchronous transmitting circuit, it transmits a string of 32 bit code. This remote control code has characteristics as follows:

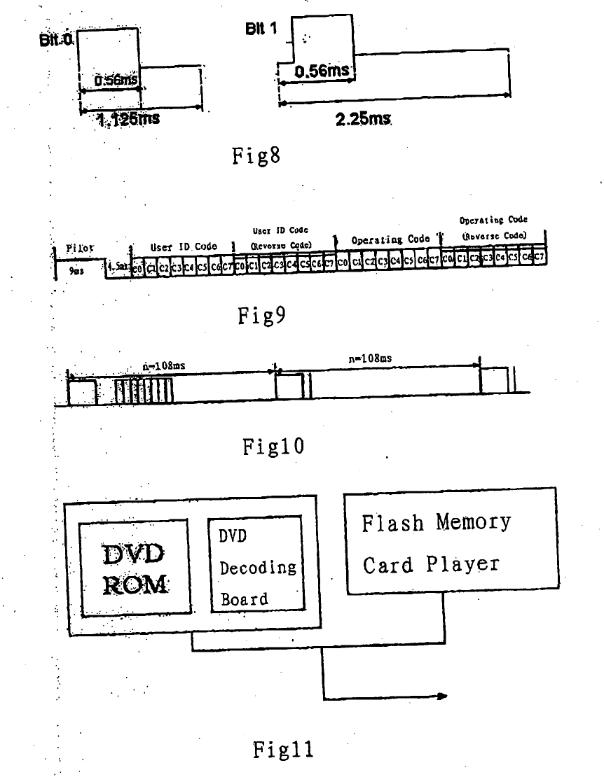

To use the combination of the pulse width modulation serial codes with a pulse width of 0.565 ms, an interval of 0.56 ms, a period of 1.125 ms to represent binary “0” and to use the combination of the pulse modulation serial codes with a pulse width of 0.565 ms, an interval of 1.685 ms, a period of 2.25 ms to represent binary “1”. The waveform is shown in FIG. 8.

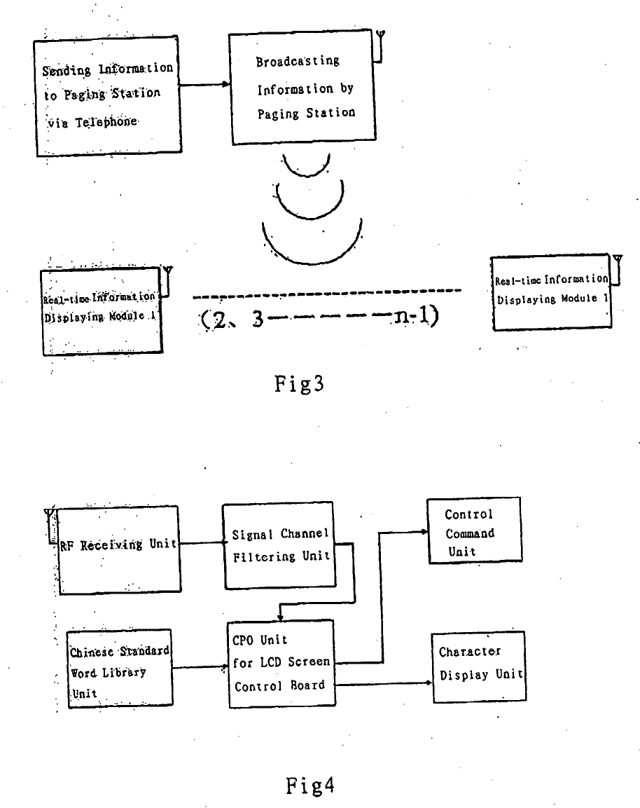

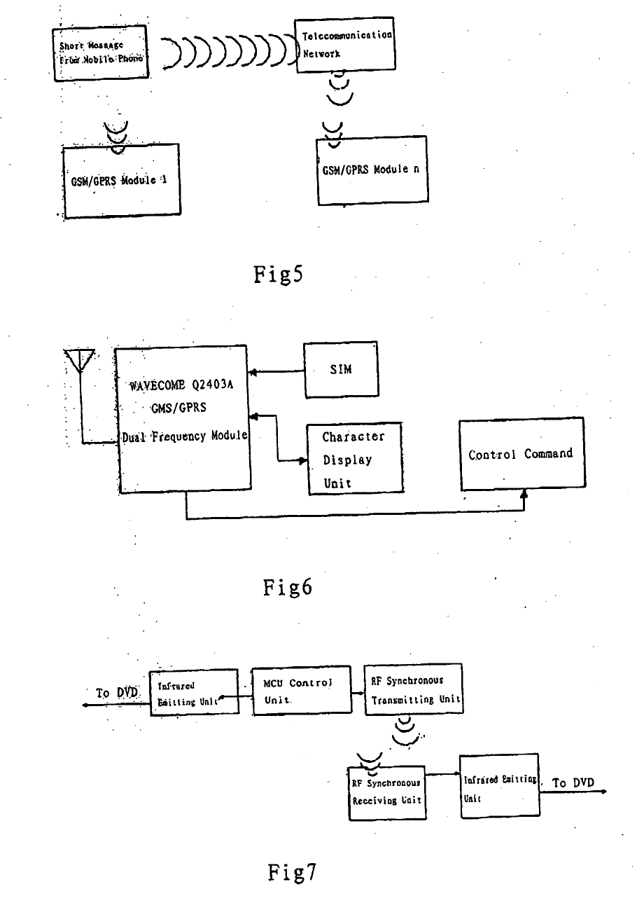

The 32 bit binary code consisting of the above-said “0” and “1” is modulated by 38 kHz carrier frequency. The efficiency of the transmission is increased so as to reduce power dissipation of the power supply. Then the code is modulated secondarily by IR light emitting diode (LED) to produce infrared light to transmit outwards. As shown in FIG. 3, the remote code produced by SC 6121 circuit is a continuous 32 bit binary code. The former 16 bits are consisted of 8 bit user identification codes and their reverse codes, to distinguish different electrical equipments, and latter 16 bits is consisted of 8 bit operation codes (functional codes) and their reverse codes.

The remote controller periodically transmits a same kind of 32 bit binary codes with a period of 108 ms, after a key-press is pressed. The duration of a set of codes themselves depends on the numbers of binary “0” and “1” contained thereof, is about 45˜63 ms. FIG. 9 shows waveform of the remote codes and FIG. 10 shows periodic waveform of the remote signal.

It is supposed that the code is a reset code of the DVD decoding board (or a reset code of flash memory card player). Through the synchronous transmitting and receiving circuits, two LCD multimedia players for use in the buildings can be simultaneously back to the initial value to start the playing so as to realize the purpose that the two LCD multimedia players for use in the buildings can simultaneous implement the playing.

The synchronous receiving module comprises a RF synchronous receiving unit and an IR emitting unit.

The RF synchronous receiving unit receives the RF signal transmitted by said RF synchronous transmitting unit in said synchronous transmitting module via an antenna. The RF signal is high frequency amplified (with the gain of 15-20 DB), the amplified signal is mixed with in a local oscillating signal (316.8 M) in a mixer to generate a 1.8 M intermediate frequency signal. The IF signal is amplified in intermediate frequency band to output to a comparator. Then the signal is amplified and shaped in the comparator. Lastly, a high level pulse signal is transmitted to the IR emitting unit. The operating principle of the IR emitting unit in the synchronous receiving module is the same as that of the IR emitting unit in the synchronous transmitting module, it transmits a IR control signal outwards.

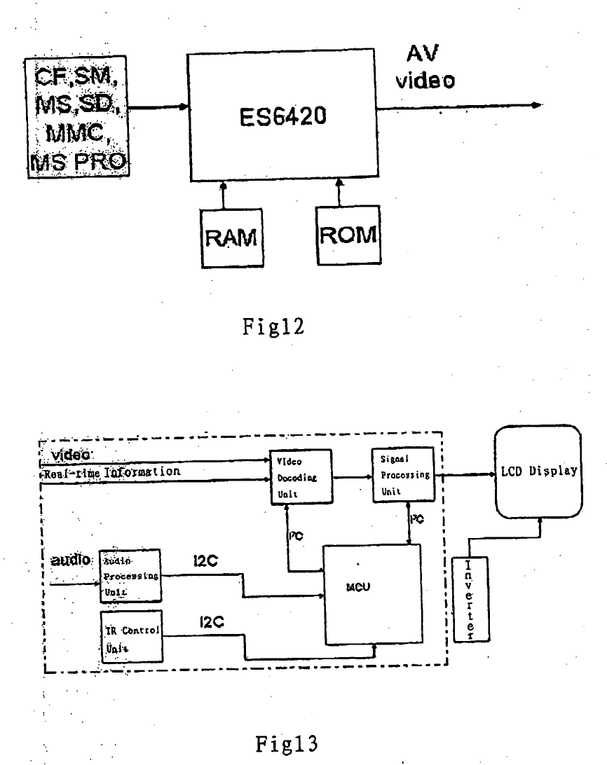

Further referring to FIG. 11, the video input source module utilizes a DVD player or a flash memory card player. The DVD player and flash memory card player both output video signal.

The DVD player comprises an ultra-thin DVD ROM, a DVD decoding board, IR receiving head. The DVD ROM reads data on an optical disc, the data is transported to the DVD decoding board. The DVD decoding board decodes the data as S-VIDEO, AUDIO, and VIDEO signals. The three sets of signals are sent to the LCD screen control board CPU so as to finally display image content. The LCD screen is of different sizes of 15, 17, 18, 20, 29, 40 inch. The ultra-thin DVD ROM (DVD-5, DVD-9, DVD-10, DVD-18) supports general formats of DVD-R, DVD+R, DVD-RW, DVD+RW, CVD11/1.2/2.0, SVCD, CD and so on.

DVD decoding board uses an ESS6008 decoding chip and MPEG-II decoding technology. It supports AC-3 and DTS dual decoding functions and supports PAL/NTCS formats and S-VIDEO, AUDEO, and VIDEO output ports.

The flash memory card player also comprises an IR receiving head. The flash memory card player uses an ESS6420 chip provided by ESS company. The ESS6420 chip reads and decodes data in the flash memory card. Then the data is sent to the LCD screen control module via S-VIDEO, AUDIO, and VIDEO output ports. The ESS 6420 chip is required to hand RAM and ROM externally (as shown in FIG. 12). The flash memory card player supports six kinds of storage cards, i.e., CF, SM, SD, MMC, MS, MS PRO. These cards are standard cards commonly used in the world.

The formats for supporting to play files comprise MPEG1/MPEG2/MPEG4, AVI, JPEG, MP3, WMA.

The output ports for supporting AUDIO, VIDEO, S-VIDEO and so on, can also support PAL/NTSC formats.

The IR receiving head uses a general IR receiving head and has the function of reading 32 bit remote control code transmitted by a remote controller and sending it to the DVD decoding board or flash memory card playing circuit so as to complete the instruction from the user.

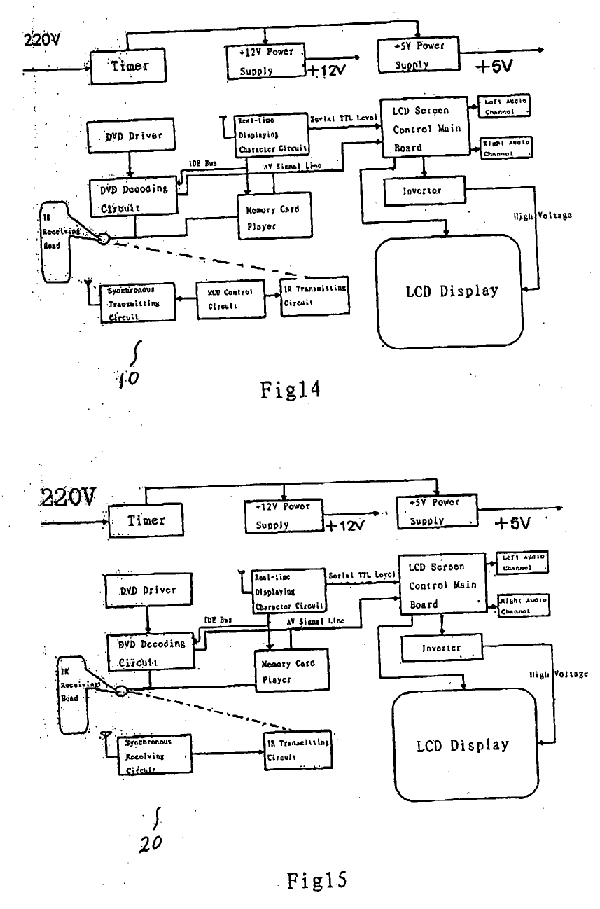

Now referring to FIG. 13, the LCD display module comprises a LCD screen control main board (the dashed block portion), a LCD screen and an inverter. The LCD screen control main board receives the AV signal sent from the DVD player or flash memory card player. The signal is processed and transferred to the LCD screen to be displayed. The inverter converts DC voltage into a high voltage to drive the background light source of the LCD screen.

The LCD screen control main board further comprises a video decoding unit, a video signal processing unit, an audio processing unit, an IR control unit, and a microprocessor unit (MCU). The video decoding unit performs decoding process to the inputted video signal and the real-time information. The processed signal is transferred to the LCD screen through the signal processing unit. The audio processing unit performs audio process to the inputted audio signal and sends it to a loudspeaker. The IR control unit receives an IR receiving signal to trigger the microprocessor unit to control lightness, contrast and volume of the display.

The LCD screen control main board receives AV signal from the DVD player (or flash memory card player). After performing a series of processes, the signal is sent to the LCD screen in the form of LVDS or TTL signal. On the other hand, the LCD screen control main board receives the signal from the real-time information display module. After performing processes, the signal is displayed on the LCD screen in the form of characters. In addition, the LCD screen control main board transports +12V, +5V DC voltage to the inverter. The inverter converts it into a high voltage to drive the background light source of the LCD screen, which is used as the light source of the display. The LCD screen control to send left and right channel signals to the loudspeaker.

The inverter can be selected properly based on different LCD screens.

+12V power supply, +5V power supply, 220V AC power supply provided in the power supply timing control module are provided to the +12V DC switch power supply and +5V DC switch power supply by the timer. The on-off state of input 220V AC power supply can be set freely by the timer so as to control the stats of automatic turn on and turn off of the LCD multimedia players for use in the buildings. The timer is comprised of a charging module and a periphery circuit. 12 sets of on-off control states can be set by the timer (that is not described in detail herein).

In the above mentioned information releasing system, only when the master transmitter and slave receiver are needed to play the same content, it is needed to use the master transmitter and slave receiver as a whole system.

The master transmitter and slave receiver in the information broadcasting system can be used separately and respectively. Thus, the structure and operation of master transmitter 10 in the multimedia information broadcasting system is the same as mentioned above. The transmitter comprises a power supply timing control module, a video input module, a real-time information display module, a LCD display module, and a synchronous transmitting module.

The power supply timing control module provides an operating power supply to other modules in said master transmitter and controls on-off state of each module in said master transmitter.

The video input module decodes content stored in a storage medium or playback card and converts it into video signal and audio signal which are provided to said LCD display module.

The real-time information display module receives kinds of real-time information transmitted from a paging station and sends said information to said LCD display module.

The LCD display module judges functions of said real-time information sent from said real-time information display module, plays back said content in said storage medium or playback card, and displays designated information.

The synchronous transmitting module transmits a synchronous control signal to said slave receiver while controlling said LCD display module to display said content in said storage medium or playback card and said designated information.

The real-time information display module further comprises a RF receiving unit, a signal channel filtering unit, a Chinese standard word library unit, a LCD screen control board CPU unit, a character display unit and a control command unit.

Said RF receiving unit receives radio paging signal and demodulates a high frequency signal to binary level signal which is sent to said signal channel filtering unit.

Said signal channel filtering unit receives and filters said binary level signal, then said filtered binary level signal is transferred to said LCD screen control board CPU unit.

The LCD screen control board CPU unit judges whether said binary level signal is a control signal or a display signal. If the signal is a control signal, said control command unit further judges whether the control signal is used to control on-off state of said timer or to control said content played back from the storage medium. If the binary level signal is a display signal, corresponding character dot array is extracted from the Chinese standard word library and transferred to said character display unit.

The synchronous transmitting module further comprises an infrared emitting unit, a MCU control unit, and a RF synchronous transmitting unit.

The MCU control unit simultaneously transmits a high level trigger signal to said RF synchronous transmitting unit, and a level trigger signal to said IR emitting unit at a fixed trigger time so as to make the IR emitting unit transmit an infrared control signal outwards and said RF synchronous transmitting unit transmit a RF signal outwards.

The MCU control unit is an AT89C2051 single processor, and the signal transmitted by the RF synchronous transmitting unit has a peak power of 0.25 W at an operation frequency of 315 MHz.

The video input module uses a DVD player or a flash memory card player.

The LCD display module mainly comprises a LCD control main board, a LCD screen, and an inverter. The LCD control main board receives and processes AV signal transferred from the DVD player or flash memory card player, and then the processed AV signal is transferred to the LCD screen to display. The inverter inverts a DC voltage into a high voltage signal to drive a background light source of said LCD screen.

The LCD control main board further comprises a video decoding unit, a video processing unit, an audio processing unit, an IR control unit, and a microprocessor unit. The video decoding unit decodes the inputted video signal and real-time information. The decoded video signal and real-time information is processed in the video processing unit. The processed signal is transferred to the LCD screen from the video processing unit. The inputted audio signal is processed by the audio processing unit and the processed audio signal is transferred to a loudspeaker. The IR control unit receives an IR signal to trigger the microprocessor unit to control lightness, contrast and volume of the display.

Similarly, the slave receiver 20 in a multimedia information releasing system in buildings, comprises a power supply timing control module, a video input module, a real-time information display module, a LCD display module, and a synchronous receiving module.

The power supply timing control module provides a operating power supply to other modules in said slave receiver and controlling on-off state of each module in said slave receiver.

The video input module decodes content stored in a storage medium or playback card and converts it into video signal and audio signal which are provided to said LCD display module.

The real-time information display module receives various kinds of real-time information transmitted from a paging station and sends the information to said LCD display module.

The LCD display module judges functions of said real-time information sent from said real-time information display module, plays back said content in said storage medium or playback card, and displays the designated information.

The synchronous receiving module receives a synchronous control signal transmitted from said synchronous transmitting module in said master transmitter while controlling said LCD display module to display said content in said storage medium or playback card and said designated information.

The real-time information display module further comprises a RF receiving unit, a signal channel filtering unit, a Chinese standard word library unit, a LCD screen control board CPU unit, a character display unit and a control command unit.

The RF receiving unit receives radio paging signal, demodulates a high frequency signal to binary level signal and transfers it to said signal channel filtering unit.

The signal channel filtering unit receives and filters said binary level signal, and said filtered binary level signal is transferred to said LCD screen control board CPU unit.

The LCD screen control board CPU unit judges whether said binary level signal is a control signal or a display signal. If the signal is a control signal, said control command unit further judges whether the control signal is used to control on-off state of said timer or to control said content played back from said storage medium. If the signal is a display signal, corresponding character dot array is extracted from said Chinese standard word library unit and transferred to said character display unit.

The synchronous receiving module further comprising a RF synchronous receiving unit and an IR emitting unit.

The RF synchronous receiving unit receives said RF signal transmitted by said RF synchronous transmitting unit in said synchronous transmitting module. After the signal is amplified, mixed, amplified and shaped, a high level pulse signal is transmitted to said IR emitting unit. The IR emitting unit emits a IR control signal outward.

The video input module utilizes a DVD player or a flash memory card player.

The LCD display module mainly comprises a LCD control main board, a LCD screen, and inverter. The LCD control main board receives and processes AV signal transferred from said DVD player or said flash memory card player, and then the processed AV signal is transferred to said LCD screen to display. The inverter inverts a DC voltage into a high voltage signal to drive a background light source of said LCD screen.

The LCD control main board further comprises a video decoding unit, a video processing unit, an audio processing unit, an IR control unit, and a microprocessor. The video decoding unit decodes the inputted video signal and real-time information. The decoded video signal and real-time information is processed in the video processing unit. The processed signal is transferred to said LCD screen from the video processing unit. The audio processing unit processes the inputted audio signal and the processed audio signal is transferred to a loudspeaker. The IR control unit receives an IR signal to trigger said microprocessor to control lightness and contrast and volume of the display.

Lastly referring to FIG. 14 and FIG. 15, they respectively show block diagram of the master transmitter and the slave receiver in the multimedia information promulgating system for use in buildings according to the present invention.

In the master transmitter 10, 220V AC power supply is provided to a timer which control on-off of the AC power supply, and then transferred to +12V power supply and +5V power supply. +15V power supply and +5V power supply are needed by the master transmitter. The video source signal is provided from DVD optical driver/DVD decoding board or memory card player. The AV signal is transferred to the LCD screen control board. The real-time information character circuit decides whether the received information is control information or display information. If it is control information, the information is sent to the video source. If it is display information, the information is sent to the LCD screen control main board. The LCD screen control main board transfers all the display information to the LCD screen. The function of the high voltage is to light the LCD screen. The MCU control circuit transmits a control signal to the synchronous transmitting circuit and IR transmitting circuit at a fixed time. The synchronous transmitting circuit transmits the signal to the synchronous receiving circuit in the receiver. The IR transmitting circuit transmits a signal to IR receiving head in the master transmitter.

In the slave receiver 20, 220V AC power supply is provided to a timer which controls on-off of the AC power supply, and then to +12V power supply and +5V power supply. +15V power supply and +5V power supply are needed by the slave receiver. The video source signal is provided from DVD optical driver/DVD decoding board or memory card player. The AV signal is transferred to the LCD screen control board. The real-time information character circuit decides whether the received information is control information or display information. If it is control information, the information is sent to the video source. If it is display information, the information is sent to the LCD screen control main board. The LCD screen control main board transfers all the display information to the LCD screen. The function of the high voltage is to light the LCD screen. The synchronous receiving circuit receives the signal transmitted from the master transmitter. A signal is transmitted to the IR transmitting circuit in the receiver so as to operate synchronously with the transmitter.

While installing, the install boards are firstly fixed on the walls of the building by the double-side adhesive tape or silica gel, then the master transmitter and the slave receivers in the multimedia information promulgating system can be hung on the install boards, without destroying the structure of the buildings. The installation is convenient and safe.

### INDUSTRIALLY APPLICATION

The multimedia information promulgating system for use in the buildings in accordance with the invention comprises a master transmitter and one or more slave receivers. The master transmitter includes a power supply timing control module, a video input module, a real-time information display module, a LCD display module, and a synchronous transmitting module. The slave receiver comprises a power supply timing control module, a video input module, a real-time information display module, a LCD display module, and a synchronous receiving module. The receiving and playing back functions of the video signal and real-time information are integrated in one information broadcasting system. Because the master transmitter controls the slave receiver in the wireless manner, the synchronous and cyclic playing back of a plurality of slave receiver can be realized in a certain range. The real-time information transmitted by the paging state can be played back in the rolling character manner. The master transmitter and slave receivers for use in the multimedia information promulgating system can be operated separately and respectively. The installation of the system, or the master transmitter and slave receivers in the system can be implemented by adhesive manner without destroying the wall structure in the buildings, therefore, they are particularly suitable to be used in these buildings that have been decorated and there is a need to release advertisements and information. In addition, the turn-on and turn-off time of the multimedia information promulgating system can be set automatically without intervening.

1-21. (canceled)

22. A master transmitter used in a multimedia information releasing system, comprising:
a video source input module for decoding contents stored in a storage medium into video and audio signal;
a real-time information display module for receiving real-time information transmitted via a wireless channel;
a LCD display module coupled to said video source input module and said real-time information display module, for receiving and reproducing said video and audio signal and said real-time information; and
a synchronous transmitting module for transmitting a synchronous control signal and controlling reproducing operation of said LCD display module.

23. The master transmitter according to claim 22, said real-time information display module comprising a RF receiving unit, a signal channel filtering unit, a Chinese standard word library unit, a LCD screen control board CPU unit, a character display unit and a control command unit, wherein said RF receiving unit receiving radio paging signal, demodulating a high frequency signal to binary level signal and transferring it to said signal channel filtering unit; said signal channel filtering unit receiving and filtering said binary level signal, and transferring said filtered binary level signal to said LCD screen control board CPU unit; said LCD screen control board CPU unit deciding whether said binary level signal is a control signal or a display signal, if said binary level signal is a control signal, said control command unit further decides whether said control signal is used to control a on-off of said timer or to control said content playback from said storage medium; if said binary level signal is a display signal, corresponding character dot array is extracted from said Chinese standard word library and transferred to said character display unit.

24. The master transmitter according to claim 22, said synchronous transmitting module comprising an infrared emitting unit, a MCU control unit, a RF synchronous transmitting unit, wherein said MCU control unit simultaneously sending a high level trigger signal to said RF synchronous transmitting unit, and sending a level trigger signal to said IR emitting unit at a predetermined trigger time so that said IR emitting unit emits an infrared control signal outwards and said RF synchronous transmitting unit transmits a RF signal outwards.

25. The master transmitter according to claim 22, wherein said video source input module is a DVD player or a flash memory card player.

26. The master transmitter according to claim 22, said LCD display module mainly comprising a LCD control main board, a LCD screen, and an inverter, wherein said LCD control main board receiving and processing AV signal transferred from said DVD player or said flash memory card player, and then transferring said processed AV signal to said LCD screen to display, said inverter inverts a DC voltage into a high voltage signal to drive a back light source of said LCD screen.

27. The master transmitter according to claim 22, said LCD control main board further comprising a video decoding unit, a video processing unit, an audio processing unit, an IR control unit, and a microprocessor, wherein said video decoding unit decoding inputted video signal and real-time information, said video processing unit processing said decoded video signal and real-time information to produce a processed signal which is transferred to said LCD screen, said audio processing unit processing inputted audio signal and transferring processed audio signal to a loudspeaker, said IR control unit receiving a IR signal to trigger said microprocessor to control lightness and contrast and volume of the display.

28. A slave receiver in a multimedia information releasing system, comprising:
a video source input module for decoding contents stored in a storage medium into video and audio signal;
a real-time information display module for receiving real-time information transmitted via a wireless channel;
a LCD display module coupled to said video source input module and said real-time information display module, for receiving and reproducing said video and audio signal and said real-time information; and
a synchronous receiving module for receiving a synchronous control signal and controlling reproducing operation of said LCD display module.

29. The slave receiver according to claim 28, said real-time information display module comprising a RF receiving unit, a signal channel filtering unit, a Chinese standard word library unit, a LCD screen control board CPU unit, a character display unit and a control command unit, wherein said RF receiving unit receiving radio paging signal, demodulating a high frequency signal to binary level signal and transferring it to said signal channel filtering unit; said signal channel filtering unit receiving and filtering said binary level signal, and transferring said filtered binary level signal to said LCD screen control board CPU unit; said LCD screen control board CPU unit deciding whether said binary level signal is a control signal or a display signal, if said binary level signal is a control signal, said control command unit further decides whether said control signal is used to control a on-off of said timer or to control said content playback from said storage medium; if said binary level signal is a display signal, corresponding character dot array is extracted from said Chinese standard word library and transferred to said character display unit.

30. The slave receiver according to claim 28, said synchronous receiving module comprising a RF synchronous receiving unit and an IR emitting unit, wherein said RF synchronous receiving unit receiving said RF signal transmitted by said RF synchronous transmitting unit in said synchronous transmitting module, amplifying, mixing, amplifying and shaping said RF signal to produce a high level pulse signal, and transferring said high level pulse signal to said IR emitting unit which emits a IR control signal outward.

31. The slave receiver according to claim 28, said video source input module is a DVD player or a flash memory card player.

32. The slave receiver according to claim 28, said LCD display module mainly comprising a LCD control main board, a LCD screen, and an inverter, wherein said LCD control main board receiving and processing AV signal transferred from said DVD player or said flash memory card player, and then transferring said processed AV signal to said LCD screen to display, said inverter inverts a DC voltage into a high voltage signal to drive a back light source of said LCD screen.

33. The slave receiver according to claim 28, said LCD control main board comprising a video decoding unit, a video processing unit, an audio processing unit, an IR control unit, and a microprocessor, wherein said video decoding unit decoding inputted video signal and real-time information, said video processing unit processing said decoded video signal and real-time information to produce a processed signal which is transferred to said LCD screen, said audio processing unit processing inputted audio signal and transferring processed audio signal to a loudspeaker, said IR control unit receiving a IR signal to trigger said microprocessor to control lightness and contrast and volume of the display.

34. A multimedia information releasing system, comprising:
(1) the master transmitter according to claim 1; and
(2) at least one slave receiver comprising:
a video source input module for decoding contents stored in a storage medium into video and audio signal;
a real-time information display module for receiving real-time information transmitted via a wireless channel;
a LCD display module coupled to said video source input module and said real-time information display module, for receiving and reproducing said video and audio signal and said real-time information; and
a synchronous receiving module for receiving a synchronous control signal and controlling reproducing operation of said LCD display module.

35. The system according to claim 34, said real-time information display module comprising a RF receiving unit, a signal channel filtering unit, a Chinese standard word library unit, a LCD screen control board CPU unit, a character display unit and a control command unit, wherein said RF receiving unit receiving radio paging signal, demodulating a high frequency signal to binary level signal and transferring it to said signal channel filtering unit; said signal channel filtering unit receiving and filtering said binary level signal, and transferring said filtered binary level signal to said LCD screen control board CPU unit; said LCD screen control board CPU unit deciding whether said binary level signal is a control signal or a display signal, if said binary level signal is a control signal, said control command unit further decides whether said control signal is used to control a on-off of said timer or to control said content playback from said storage medium; if said binary level signal is a display signal, corresponding character dot array is extracted from said Chinese standard word library and transferred to said character display unit.

36. The system according to claim 34, said synchronous transmitting module comprising an infrared emitting unit, a MCU control unit, a RF synchronous transmitting unit, wherein said MCU control unit simultaneously sending a high level trigger signal to said RF synchronous transmitting unit, and sending a level trigger signal to said IR emitting unit at a predetermined trigger time so that said IR emitting unit emits an infrared control signal outwards and said RF synchronous transmitting unit transmits a RF signal outwards.

37. The system according to claim 34, wherein said video source input module is a DVD player or a flash memory card player.

38. The system according to claim 34, said LCD display module mainly comprising a LCD control main board, a LCD screen, and an inverter, wherein said LCD control main board receiving and processing AV signal transferred from said DVD player or said flash memory card player, and then transferring said processed AV signal to said LCD screen to display, said inverter inverts a DC voltage into a high voltage signal to drive a back light source of said LCD screen.

39. The system according to claim 34, said LCD control main board further comprising a video decoding unit, a video processing unit, an audio processing unit, an IR control unit, and a microprocessor, wherein said video decoding unit decoding inputted video signal and real-time information, said video processing unit processing said decoded video signal and real-time information to produce a processed signal which is transferred to said LCD screen, said audio processing unit processing inputted audio signal and transferring processed audio signal to a loudspeaker, said IR control unit receiving a IR signal to trigger said microprocessor to control lightness and contrast and volume of the display.
